(19) United States
(12) Patent Application Publication
(10) Pub. No.: US 2004/0020112 A1
(43) Pub. Date: Feb. 5, 2004

(54) Weed barriers and control methods

(76) Inventor: Max Lloyd, Chapel Hill, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(21) Appl. No.: 10/210,927

(22) Filed: Aug. 2, 2002

(51) Int. Cl. A01G 1/00

(52) U.S. Cl. 47/33

(57) ABSTRACT

A rigid or semi-rigid panel of metal, molded plastic, vinyl or the like disposed between two adjacent vines, trees, or other plants for controlling the growth of weeds between the adjacent plants. The panel may have a length corresponding to the distance between the adjacent plants. One or more cutouts may be included in the panel to facilitate closer coverage around the trunk or stalk of the plant. Opposite side of the panel may be light- and dark-colored to improve reflectivity and absorptivity, respectively. Water barriers may be added to the panels to direct the flow of water as desired.

### FIELD OF THE PRESENT INVENTION

The present invention relates generally to the field of plant husbandry, and more particularly to the field of apparatuses and materials for effecting weed control in vineyards, orchards, tree farms and other agricultural environments.

### BACKGROUND OF THE PRESENT INVENTION

A well-known problem faced by viticulturists and other farmers is the prevention of unwanted weeds. Growers frequently control the growth of weeds by applying herbicides to the weeds or the ground around the plants. Unfortunately, herbicides are expensive and time-consuming to apply. In addition, the chemicals used in the herbicides may damage the plants, the soil, or the persons applying them. Moreover, herbicides may not be completely effective against all weeds or all types of weeds.

One alternative to herbicides is the use of sheets of plastic, cloth or other materials that may be unrolled and spread out between or around the plants to prevent weeds from growing between them. Unfortunately, such materials are expensive, tear easily, slow to install, and must be weighted down in order to hold them in place. Rarely are such materials reusable, because they are too difficult to roll back up and they degrade too much for reuse.

One historical solution in vineyards has been the use of large quantities of rocks piled on the ground around and between plants. Unfortunately, installing the rock-piles is extremely time-consuming and labor-intensive and requires more rocks than are commonly available in many vineyards, particular those in the United States. In addition, some weeds inevitably grow up through the cracks between the rocks.

Known weed control alternatives are also incapable of providing certain other benefits. For example, herbicides have no effect on the reflection or absorption of sunlight and are incapable of controlling the flow of water. Although some rolled plastics and textiles may be light- or dark-colored, thereby having an effect on the reflection or absorption of sunlight, these materials may not be reversed in order to switch between reflecting light and absorbing light. Further, neither the rolled materials nor the rock-piles may be used to direct water in a desired direction.

A need exists for an inexpensive, easily installed, and highly effective apparatus for controlling weeds in vineyards, orchards, tree farms and other agricultural environments.

### SUMMARY OF THE PRESENT INVENTION

Briefly summarized, the present invention relates to panels and methods for controlling the growth of weeds between adjacent plants. Broadly defined, a method of controlling weed growth between adjacent plants according to one aspect of the present invention includes: supplying a plurality of rigid or semi-rigid panels; installing a first panel of the plurality of panels in a first location between a pair of adjacent plants; installing a second panel of the plurality of panels in a second location between a pair of adjacent plants; and maintaining the first and second panels in their respective locations for a period of time sufficient to inhibit weed growth.

In features of this method, the step of supplying a plurality of panels includes supplying a plurality of panels of sufficient weight to resist being overturned by natural forces; the steps of installing the first and second panels each include placing the respective panel flat on the ground between the respective pair of adjacent plants; the first location is between a first pair of adjacent plants, the second location is between a second pair of adjacent plants, and the first pair of adjacent plants lies in the same row as the second pair of adjacent plants; the steps of installing the first and second panels includes aligning the first and second panels in the row containing the first and second pairs of plants; the step of supplying a plurality of panels includes supplying a plurality of panels having at least one cutout therein, and the step of installing the first panel includes arranging the first panel such that its cutout is disposed at least partially around the plant; the steps of installing the first and second panels each include the step of completely covering substantially all of the ground between the respective pair of adjacent plants; the first location and the second location each lie between the same pair of adjacent plants, and the method further includes arranging the first and second panels to completely cover substantially all of the ground between the pair of adjacent plants; and the step of supplying a plurality of panels includes supplying a plurality of panels having opposite ends, and the step of installing the second panel includes installing the second panel such that one end of the second panel is substantially adjacent to one end of the first panel.

In another aspect of the present invention, an apparatus for controlling weed growth between adjacent plants includes: a rigid or semi-rigid panel having a length corresponding to the distance between the adjacent plants; and a cutout in the panel, the cutout having dimensions corresponding to the size of at least one of the plants.

In features of this aspect, the cutout extends inward from the periphery of the panel; the cutout is completely surrounded by the panel; the cutout is angularly shaped or curvilinearly shaped; the panel includes two oppositely-facing planar surfaces, one of which tends to reflect light and the other of which tends to absorb light; and the panel is constructed of galvanized metal or gutter vinyl.

In yet another aspect of the present invention, an apparatus for controlling weed growth and water flow between adjacent plants includes: a rigid or semi-rigid panel having a length corresponding to the distance between the adjacent plants; and a water barrier disposed on the panel for directing the flow of water on the panel.

In features of this aspect, the water barrier is oriented to direct water toward at least one of the adjacent plants; the water barrier is oriented to direct water away from at least one of the adjacent plants; the water barrier is a piece of lumber; the water barrier is fastened to the panel; and the water barrier is pivotally fastened to the panel.

### BRIEF DESCRIPTION OF THE DRAWINGS

Further features, embodiments, and advantages of the present invention will become apparent from the following detailed description with reference to the drawings, wherein:

FIG. 1 is a schematic diagram showing panels of the present invention installed along a row of plants;

FIG. 2 is a schematic diagram illustrating the use of panels having cutouts;

FIGS. 3A, 3B and 3C are schematic diagrams of panels of the present invention showing alternative cutout arrangements;

FIGS. 4A, 4B and 4C are schematic diagrams of panels of the present invention showing alternative curvilinear cutout arrangements;

FIG. 5 is a schematic diagram of a panel having a light-colored side and a dark-colored side; and

FIGS. 6A and 6B are schematic diagrams of one of the panels of FIG. 1 with water barriers installed.

### DETAILED DESCRIPTION OF THE PREFERRED EMBODIMENTS

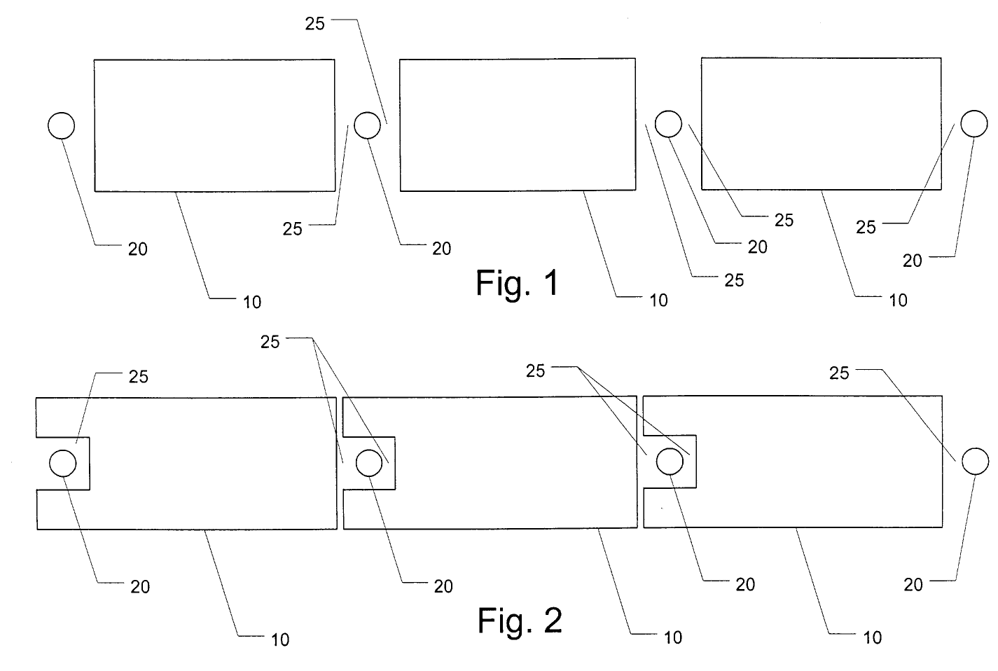

The present invention comprises one or more rigid or semi-rigid panels 10 of weighted material dimensioned to fit between adjacent plants 20 in an agricultural setting. FIG. 1 is a schematic diagram showing panels 10 of the present invention installed along a row of plants 20. Each panel 10 must be stiff enough to maintain its shape when handled roughly or subjected to heavy wind or rain. However, it is not necessary that the panels 10 be perfectly rigid as long as the panels 10 maintain their general shape when installed in their typical environment.

Preferably, each panel 10 is opaque in nature in order to prevent sunlight from passing therethrough, thereby inhibiting plant life therebelow. Also preferably, each panel 10 is generally flat to permit easy stacking for storage, transport or shipping. In addition, flat panels 10 are less likely to be overturned by heavy wind and may easily be traversed by workers, farm equipment and the like. The panels 10 may be constructed from any material with enough weight and rigidity to resist unintended movement under the forces of wind, rain, surface water, animals, workers, equipment, and the like. Generally, the weight and rigidity of the panels 10 may be improved by increasing the density of the material. However, each panel 10 may be additionally weighted by stationing rocks, scrap lumber or other objects on top of the panel 10 to hold it in place.

In a preferred embodiment, each panel 10 is made from a sheet of metal. One type of metal believed to be suitable for use in the present invention is galvanized tin alloy. However, suitable alternative materials include molded plastics and vinyl, including gutter-type vinyl. These materials tend not to have sharp corners or edges which may injure plants or workers alike. In one embodiment, materials of lesser density or thinner gauges may be reinforced by attaching a rigid frame of metal or wood thereto in order to provide the necessary weight and rigidity. Other suitable materials will be apparent to those of ordinary skill in the art.

In use, each panel 10 may be placed between two adjacent plants 20. Typically, the two plants 20 are disposed within the same plant row, where the spacing between the rows permit personnel and equipment to access the plants in the rows. Each panel 10 is preferably dimensioned such that when placed between two adjacent plants 20, the panel 10 covers most or all of the ground between the two plants 20, as shown in FIG. 1. The length of the panels 10 used may be chosen to correspond to the desired distance between adjacent plants 20, or the spacing between adjacent plants 20 may be chosen to correspond to the length of the panels 10 to be used. For example, in a vineyard, two adjacent vines 20 in a particular row might be planted eight feet apart, and a panel 10 of approximately seven feet in length might be used to cover substantially all of the ground between the two vines 20. It is not necessary for the panels 10 to cover the ground between adjacent rows of plants 20.

Panels 10 in a variety of sizes may be stocked in order to facilitate different plant spacings. Smaller panels 10 may be combined together to cover larger areas. For example, in the previous example, wherein two adjacent vines 20 in a particular row are planted eight feet apart, two smaller panels 10 might alternatively be used to cover substantially all of the ground between the two vines 20 by laying the smaller panels 10 end to end between the vines 20. This may be achieved using one smaller panel 10 of three feet in length and one panel 10 of four feet, or two panels 10 of four feet in length laid so that they overlap each other, or in any of a variety of other combinations. Once again, it is not necessary for the panels 10 to cover the ground between adjacent rows of plants 20.

The width of the panels 10 is dependent upon the row spacing of the plants 20, the size of the root system of the plants 20, the size of the canopy of the plants 20, the area of weed control desired, and other factors. In general, as the width decreases, the weight decreases, thus making the panels 10 more prone to movement due to wind, water, equipment and the like. On the other hand, as the width increases, the panels 10 become more difficult to handle and create more of an obstacle as workers and equipment move up and down the rows. One general purpose width suitable for use in many vineyard environments and at least some other environments is approximately three feet.

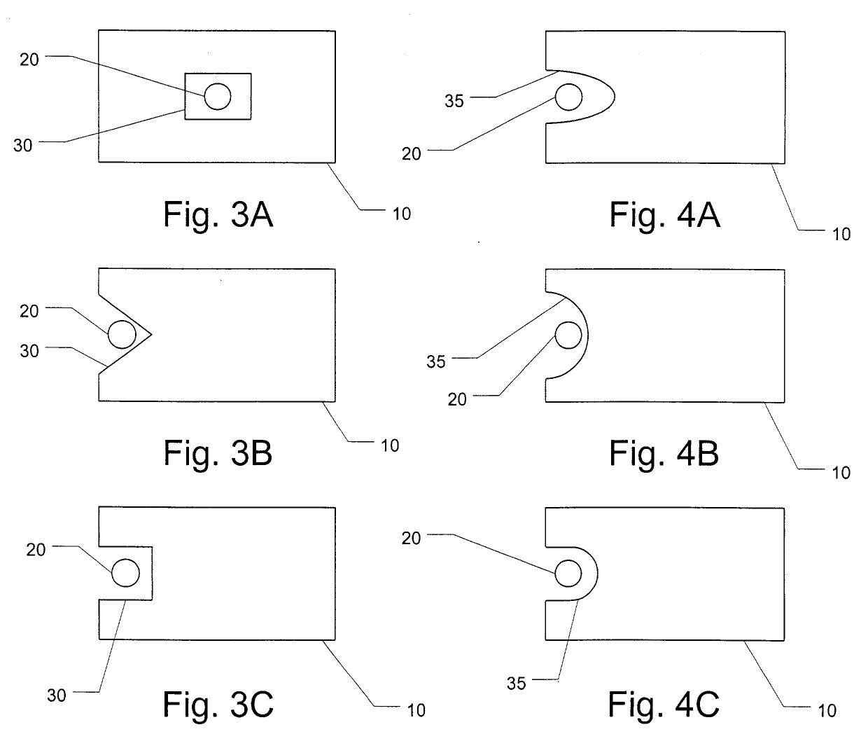

A gap 25 may preferably be left between the stalk, stem, trunk or the like of each plant 20 and the panel or panels 10 adjacent to it. The decision as to whether to leave a gap 25 and the dimensions of such a gap 25 are dependent upon a number of factors including plant type, available rainfall, whether hardware will be installed around the plant 20, and other factors, and these determinations will be well within the skill of a farmer or other user of ordinary skill. The dimensions of the gap 25 may be more precisely controlled through use of one or more cutouts 30 in the panel 10. FIG. 2 is a schematic diagram illustrating the use of panels 10 having cutouts 30. Although not required, the use of such cutouts 30 avoids the existence of a gap between the ends of adjacent panels 10 and permits closer coverage to the plant 20. FIGS. 3A, 3B and 3C are schematic diagrams of panels 10 of the present invention showing alternative cutout 30 arrangements. FIGS. 4A, 4B and 4C are schematic diagrams of panels 10 of the present invention showing alternative curvilinear cutout 35 arrangements. When compared to other cutouts of similar size, curvilinear cutouts 35 may help to lessen the chance of trunk damage.

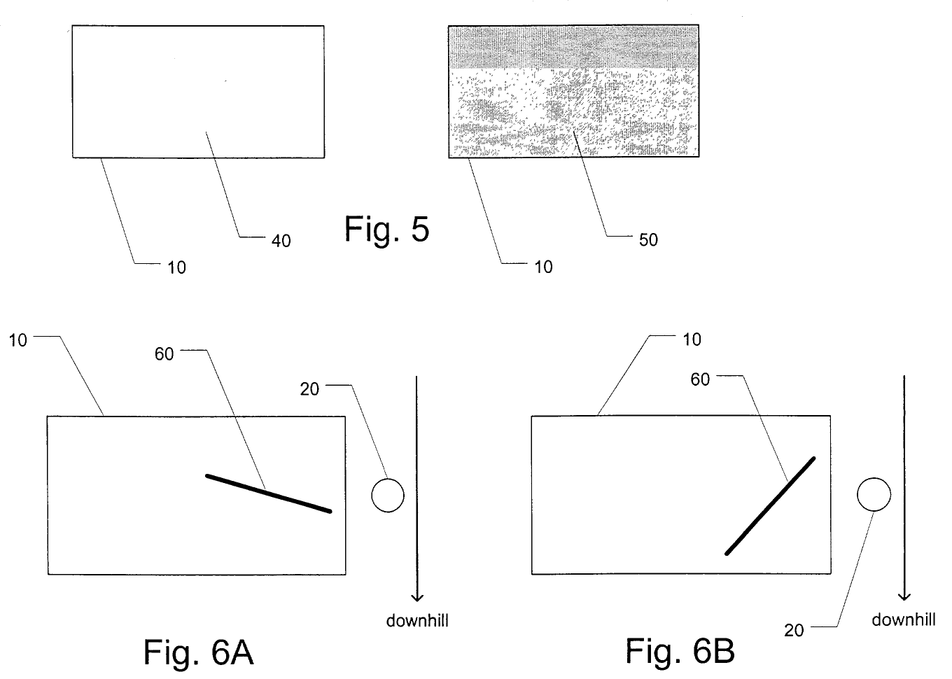

In another feature of the present invention, the optical characteristics of one or more surfaces of a panel 10 may be designed to provide additional functionality. For example, by using a light-colored, reflective material for the top surface of the panel 10, a greater amount of light may be reflected up into the foliage of the surrounding plant or plants. Similarly, by using a dark-colored, absorptive materials for the top surface of the panel 10, a greater amount of light may be absorbed by the panel 10. Optionally, opposing surfaces of a panel 10 may have different characteristics. FIG. 5 is a schematic diagram of a panel 10 having a light-colored side 40 and a dark-colored side 50. Such a panel 10 may be installed with its light-colored side 40 facing up in order to reflect sunlight, thus increasing the amount of light directed to the plant's canopy. This increased light may be desired to increase photosynthesis and may also facilitate quicker drying, which may increase growth and reduce fungal disease. On the other hand, if a panel 10 is installed with the dark-colored side 50 facing up, the panel 10 tends to absorb heat from sunlight. When installed dark-colored side 50 up during the winter, the chances of frost damage to the plants 20 may thus be decreased.

A panel 10 with light- and dark-colored sides 40, 50 may be produced in a variety of ways. A sheet of a galvanized or other shiny metal may be naturally light-colored and reflective, and one side of a sheet of such material may be painted with a dark-colored paint to produce the desired dark-colored side 50. Alternatively, both sides 40, 50 of a sheet may be painted, one with a light-colored paint and the other with a dark-colored paint. If the panel 10 is formed from vinyl, then a light-colored material may be used on one side and a dark-colored material may be used for the opposite side. Other methods and constructions for producing sides 40, 50 of contrasting colors will be apparent to one of ordinary skill in the art.

In another feature of the present invention, water barriers 60 may be used in conjunction with the panels 10 in order to control the flow of water in the vicinity of the plants 20. FIGS. 6A and 6B are schematic diagrams of one of the panels 10 of FIG. 1 with water barriers 60 installed. Each water barrier 60 may comprise a block of material placed on a panel 10 in a desired orientation to channel water that lands on a panel 10 in a desired direction. The direction may be chosen to either increase or decrease the amount of water available to a plant 20. For example, FIG. 6A shows a water barrier 60 installed to channel water toward a plant 20, while FIG. 6B shows a water barrier 60 installed to channel water away from a plant 20. One water barrier 60 suitable for use in a preferred embodiment of the present invention is a block of wood.

Although not illustrated herein, other, more complicated water barrier arrangements will be apparent to one of ordinary skill in the art. For example, water barriers 60 having a V-shaped structure could be used to funnel water in a particular direction. Further, the water barriers 60 may be fastened to the panels 10 in order to hold them in place. Optionally, the water barriers 60 may be fastened in such a way as to be adjustable as necessary to direct water in a desired direction. For example, a water barrier 60 may be pivotally attached to a panel 10 using a bolt (not shown) or other axle-like attachment means so that the water barrier 60 may be rotated into a desired orientation to direct water toward or away from a particular plant 20. Because the panels 10 of the present invention are usually impermeable to water, the use of water barriers 60 may be important in some installations as a means of compensating for the rainwater or irrigation water that is blocked from reaching a plant's root system by the panel 10.

Although described for use with grape vines, it should be clear that the present invention may likewise be used with other plants with trunks or stems, such as other vine plants, fruit trees, nut trees, and the like without departing from the scope of the present invention.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiments, it is to be understood that this disclosure is only illustrative and exemplary of the present invention and is made merely for purposes of providing a full and enabling disclosure of the invention. The foregoing disclosure is not intended, nor is it to be construed, to limit the present invention or otherwise to exclude any other embodiments, adaptations, variations, modifications and equivalent arrangements, the present invention being limited only by the claims appended hereto and the equivalents thereof

What is claimed is:

1. A method of controlling weed growth between adjacent plants, comprising the steps of:
supplying a plurality of rigid or semi-rigid panels;
installing a first panel of the plurality of panels in a first location between a pair of adjacent plants;
installing a second panel of the plurality of panels in a second location between a pair of adjacent plants; and
maintaining the first and second panels in their respective locations for a period of time sufficient to inhibit weed growth.

2. The method of claim 1, wherein the step of supplying a plurality of panels includes supplying a plurality of panels of sufficient weight to resist being overturned by natural forces.

3. The method of claim 2, wherein the steps of installing the first and second panels each include placing the respective panel flat on the ground between the respective pair of adjacent plants.

4. The method of claim 2, wherein the first location is between a first pair of adjacent plants, wherein the second location is between a second pair of adjacent plants, and wherein the first pair of adjacent plants lies in the same row as the second pair of adjacent plants.

5. The method of claim 4, wherein the steps of installing the first and second panels includes aligning the first and second panels in the row containing the first and second pairs of plants.

6. The method of claim 2, wherein the step of supplying a plurality of panels includes supplying a plurality of panels having at least one cutout therein, and wherein the step of installing the first panel includes arranging the first panel such that its cutout is disposed at least partially around the plant.

7. The method of claim 2, wherein the steps of installing the first and second panels each include the step of completely covering substantially all of the ground between the respective pair of adjacent plants.

8. The method of claim 2, wherein the first location and the second location each lie between the same pair of adjacent plants, and wherein the method further comprises the step of arranging the first and second panels to completely cover substantially all of the ground between the pair of adjacent plants.

9. The method of claim 2, wherein the step of supplying a plurality of panels includes supplying a plurality of panels having opposite ends, and wherein the step of installing the second panel includes installing the second panel such that one end of the second panel is substantially adjacent to one end of the first panel.

10. An apparatus for controlling weed growth between adjacent plants, the apparatus comprising:
a rigid or semi-rigid panel having a length corresponding to the distance between the adjacent plants; and
a cutout in the panel, the cutout having dimensions corresponding to the size of at least one of the plants.

11. The apparatus of claim 10, wherein the cutout extends inward from the periphery of the panel.

12. The apparatus of claim 10, wherein the cutout is completely surrounded by the panel.

13. The apparatus of claim 10, wherein the cutout is angularly shaped.

14. The apparatus of claim 10, wherein the cutout is curvilinearly shaped.

15. The apparatus of claim 10, wherein the panel includes two oppositely-facing planar surfaces, wherein one of the planar surfaces tends to reflect light and the other of the planar surfaces tends to absorb light.

16. The apparatus of claim 10, wherein the panel is constructed of galvanized metal.

17. The apparatus of claim 10, wherein the panel is constructed of gutter vinyl.

18. An apparatus for controlling weed growth and water flow between adjacent plants, the apparatus comprising:
a rigid or semi-rigid panel having a length corresponding to the distance between the adjacent plants; and
a water barrier disposed on the panel for directing the flow of water on the panel.

19. The apparatus of claim 18, wherein the water barrier is oriented to direct water toward at least one of the adjacent plants.

20. The apparatus of claim 18, wherein the water barrier is oriented to direct water away from at least one of the adjacent plants.

21. The apparatus of claim 18, wherein the water barrier is a piece of lumber.

22. The apparatus of claim 18, wherein the water barrier is fastened to the panel.

23. The apparatus of claim 22, wherein the water barrier is pivotally fastened to the panel.
